(19) United States
(12) Patent Application Publication
(10) Pub. No.: US 2026/0233674 A1
(43) Pub. Date: Aug. 13, 2026

(54) MIRROR ASSEMBLY

(71) Applicant: SCOUT MOTORS INC., Tysons, VA (US)

(72) Inventor: Daniel DAVIS, West Bloomfield Township, MI (US)

(21) Appl. No.: 19/050,790

(22) Filed: Feb. 11, 2025

(51) Int. Cl. B60R 1/074

(52) U.S. Cl. CPC B60R 1/074

(57) ABSTRACT

Provided herein is a system and apparatus for a mirror assembly, and more specifically, a mirror assembly that is deployable in circumstances where standard vehicle mirrors may be insufficient. Embodiments provided herein include mirror system for vehicle, the mirror system including: a mirror housing; a first mirror; a second mirror; and an actuator, where the actuator is configured to move the second mirror relative to the first mirror from a stowed position to a deployed position, where in the deployed position the first mirror and the second mirror are visible to an occupant of the vehicle, where in the stowed position, only one of the first mirror and the second mirror are visible to the occupant of the vehicle, where the first mirror is independently adjustable about two perpendicular axes, where the second mirror is independently adjustable about two perpendicular axes.

### BACKGROUND

Vehicle safety is a priority for vehicle engineering and design. With vehicle capabilities ever-improving, safety features are developed to keep pace and ensure occupant safety for all conditions. In order to safely operate a vehicle, regardless of whether the vehicle is autonomously controlled, manually driven, or any combination thereof, awareness of the vehicle and an environment of the vehicle is imperative.

Mirrors have historically been used within automobiles to provide a driver views from perspectives that a driver cannot reasonably see while facing forward in a driver's seat. These mirrors provide views aft of the vehicle and adjacent to the vehicle to help a driver navigate the environment surrounding the vehicle. These mirrors have generally been positioned as vehicle side mirrors or rear-view mirrors with a limited degree of visibility based on their positions and size.

The use of cameras to show the surroundings of a vehicle are increasingly common and can be of significant benefit to a driver of a vehicle. Back-up cameras are ubiquitous and provide valuable information regarding objects that may be behind a vehicle as it reverses. Other cameras are often used to provide a view in front and/or to the sides of a vehicle. However, each of these views are limited by virtue of where a camera can be positioned. Cameras are typically positioned on the body of a vehicle, which renders their field-of-view limited.

### BRIEF SUMMARY

A system and apparatus are therefore provided for a mirror assembly, and more specifically, a mirror assembly that is deployable in circumstances where standard vehicle mirrors may be insufficient. Embodiments provided herein include mirror system for vehicle, the mirror system including: a mirror housing; a first mirror; a second mirror; and an actuator, where the actuator is configured to move the second mirror relative to the first mirror from a stowed position to a deployed position, where in the deployed position the first mirror and the second mirror are visible to an occupant of the vehicle, where in the stowed position, only one of the first mirror and the second mirror are visible to the occupant of the vehicle, where the first mirror is adjustable about two perpendicular axes, where the second mirror is adjustable about two perpendicular axes, and where adjustment of the first mirror is independent of adjustment of the second mirror.

According to some embodiments the actuator is further configured to move the second mirror relative to the first mirror from the deployed position to a second deployed position, where the stowed position is a first distance from a side of the vehicle, the deployed position is a second distance from the side of the vehicle, and the second deployed position is a third distance from the side of the vehicle, where the third distance is greater than the first distance and the second distance. According to certain embodiments the second distance is greater than the first distance.

The mirror system of some embodiments further includes a controller, where the controller is configured to command the actuator to move the second mirror from the stowed position to the deployed position. The mirror system of certain embodiments further includes a controller where the controller is configured to command the actuator to move the second mirror from the stowed position to the deployed position in response to detection of a presence of a trailer towed by the vehicle.

According to some embodiments the detection of the presence of the trailer towed by the vehicle is based on connection of a trailer wire harness to a trailer wiring connector. According to certain embodiments the detection of the presence of the trailer towed by the vehicle is based on a selection of a tow mode by a user of the vehicle. According to some embodiments the detection of the presence of the trailer towed by the vehicle is based on a trailer object detected in a rear-view camera of the vehicle.

The actuator of some embodiments includes a mechanical linear actuator, where the second mirror moving to the deployed position slides linearly away from the vehicle. The second mirror of some embodiments in the stowed position is enclosed within the mirror housing. According to some embodiments the second mirror in the stowed position is in front of the first mirror.

The actuator of some embodiments includes a rotating actuator where the second mirror moving to the deployed position rotates about a pivot point to the deployed position further from the vehicle than the stowed position. The actuator of some embodiments is configured to move the second mirror relative to the first mirror from the stowed position to the deployed position in response to a command from a user inside the vehicle.

According to certain embodiments adjustment of the first mirror and adjustment of the second mirror is controlled by at least one user interface inside the vehicle. According to some embodiments adjustment of the first mirror and adjustment of the second mirror are performed in response to identifying a profile of a user of the vehicle.

Embodiments provided herein include a method of operating a mirror system for a vehicle including: receiving an indication to deploy a second mirror relative to a first mirror from a stowed position to a deployed position; and causing an actuator to move the second mirror from the stowed position to a deployed position, where only one of the first mirror or the second mirror are visible in response to the second mirror being in the stowed position, where both the first mirror and the second mirror are visible in response to the second mirror being in the deployed position, where the first mirror is adjustable about two perpendicular axes, where the second mirror is adjustable about two perpendicular axes, and where adjustment of the first mirror is independent of adjustment of the second mirror.

According to some embodiments the stowed position is a first distance from a side of the vehicle and the deployed position is a second distance from the side of the vehicle, where the second distance is greater than the first distance. The method of some embodiments further includes determining a presence of a trailer behind the vehicle, where receiving an indication to deploy the second mirror relative to the first mirror from the stowed position to the deployed position is in response to determining the presence of the trailer behind the vehicle. According to certain embodiments receiving the indication to deploy the second mirror relative to the first mirror from the stowed position to the deployed position comprises receiving an indication from a user interface within the vehicle.

Embodiments provided herein include a computer program product including at least one non-transitory computer-readable storage medium having computer-executable program code portions stored therein, the computer-executable program code portions comprising program code instructions configured to: receive an indication to deploy a second mirror relative to a first mirror from a stowed position to a deployed position; and cause an actuator to move the second mirror from the stowed position to a deployed position, where only one of the first mirror or the second mirror are visible in response to the second mirror being in the stowed position, where both the first mirror and the second mirror are visible in response to the second mirror being in the deployed position, where the first mirror is adjustable about two perpendicular axes, where the second mirror is adjustable about two perpendicular axes, and where adjustment of the first mirror is independent of adjustment of the second mirror.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates an example vehicle with a left side mirror and a right side mirror according to an example embodiment of the present disclosure;

FIG. 2 illustrates the vehicle of FIG. 1 towing a trailer according to an example embodiment of the present disclosure;

FIG. 3 illustrates the vehicle and trailer of FIG. 2 with deployable mirrors according to an example embodiment of the present disclosure;

FIG. 4 illustrates the vehicle and trailer of FIG. 2 with deployable mirrors in a second deployed position according to an example embodiment of the present disclosure;

FIGS. 5A-5C illustrate a deployable mirror according to an example embodiment of the present disclosure;

FIGS. 6A-6C illustrate a deployable mirror according to an example embodiment of the present disclosure;

FIGS. 7A-7C illustrate a deployable mirror according to an example embodiment of the present disclosure;

FIGS. 8A-8D illustrate a deployable mirror according to an example embodiment of the present disclosure;

FIGS. 9A-9C illustrate a deployable mirror according to an example embodiment of the present disclosure; and

FIG. 10 illustrates a block diagram of a vehicle and controller thereof for operating a deployable mirror according to an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Safe vehicle operation requires visibility of the surroundings or environment of the vehicle as it navigates along a path, regardless of whether the vehicle is manually driven by a driver, autonomously driven, or a combination thereof. Forward visibility relies on a clear view through a windshield and front windows of the vehicle to view a path ahead of the vehicle. A view rearward is more challenging particularly as that is opposite the direction that a driver faces. Further, obstructions such as passengers, cargo, and other obstacles can render a view behind a vehicle difficult for a driver to see.

Many modern vehicles are equipped with cameras to help a driver see their surroundings. Some vehicles employ cameras to also facilitate autonomous vehicle control. These cameras are useful for visibility and safety. Cameras are often found on a rear end of a vehicle, mounted several feet above ground level to provide a rear-facing view that is beneficial when the vehicle is reversing. Some cameras have been used in place of wing mirrors on a vehicle to project an image onto a screen within a vehicle as the vehicle is driven. However, there are circumstances where cameras positioned in such conventional locations are insufficient to meet a driver's need to see aft of the vehicle.

One such circumstance includes a vehicle that is engaged in towing of a trailer. A trailer towed by a vehicle provides several challenges for both the vehicle itself and a driver of the vehicle. The towing of a trailer changes handling characteristics of a vehicle, increases stopping distances, and substantially limits maneuverability. While a driver's attention should be solely focused on driving even without towing a trailer, these challenges require more concentration of a driver and require the driver to be even more keenly aware of their surroundings.

When towing a trailer, a driver needs to be aware of the trailer behavior along with vehicles and objects around the trailer. Trailer behavior involving the tracking of the trailer should be following the vehicle to which it is attached without unwanted swaying. Trailers, particularly trailers that are large and/or heavy (e.g., more than 30% of gross vehicular weight of the vehicle) can influence the handling and control of the vehicle, such that it is imperative that a driver is aware of trailer movement and behavior as a trailer is being towed. Detecting trailer sway while it is minimal can lead a driver to apply corrective action, such as actuating a trailer brake. Trailer sway tends to increase in magnitude if corrective action is not taken. Because of this, trailer visibility to a driver is a necessity to identify trailer sway early.

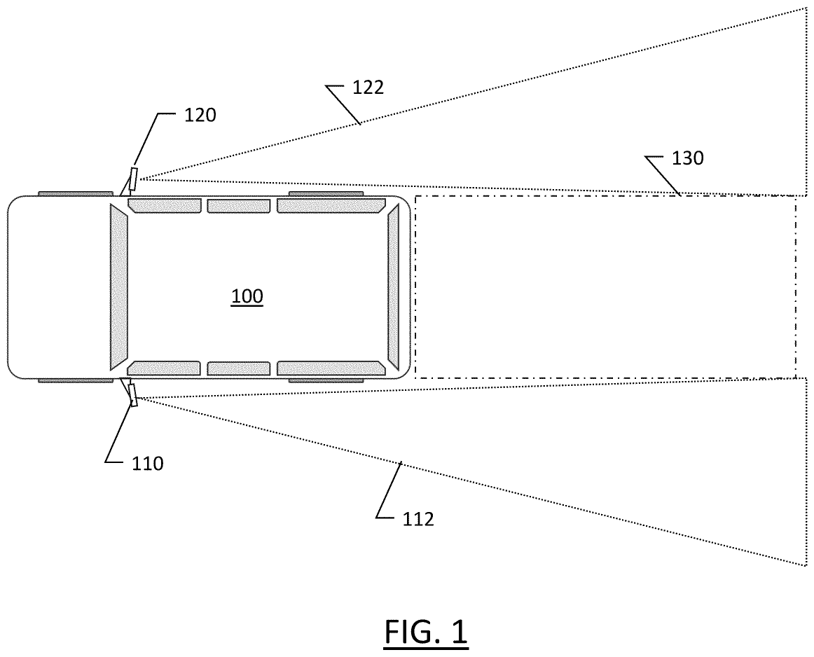

Vehicle side mirrors are generally designed for a driver to be able to view vehicles or objects aft of the vehicle and adjacent. Side mirrors, also known as door mirrors or wing mirrors are generally positioned proximate an A-pillar (e.g., the pillar adjacent a windshield) of a vehicle and typically mounted to a vehicle door, though may be mounted to a vehicle fender or A-pillar. FIG. 1 illustrates an example vehicle 100 with a left side mirror 110 and a right side mirror 120. FIG. 1 further illustrates the left side field of view 112 of the left side mirror and the right side field of view 122 of the right side mirror. As shown, the fields of view are generally adjacent and aft of the vehicle 100. This is in part due to the position of the side mirrors extending only as far from a side of the vehicle as necessary to achieve the depicted field of view. The larger a side mirror is the more frontal area exists, which reduces aerodynamic efficiency, such that minimization of the size of a side mirror is generally preferred. For a driver to see the area 130 directly behind the vehicle, a rear view mirror and/or rear view camera are generally employed which, with the side mirrors 110, 120, provide the driver with a full view aft of the vehicle 100.

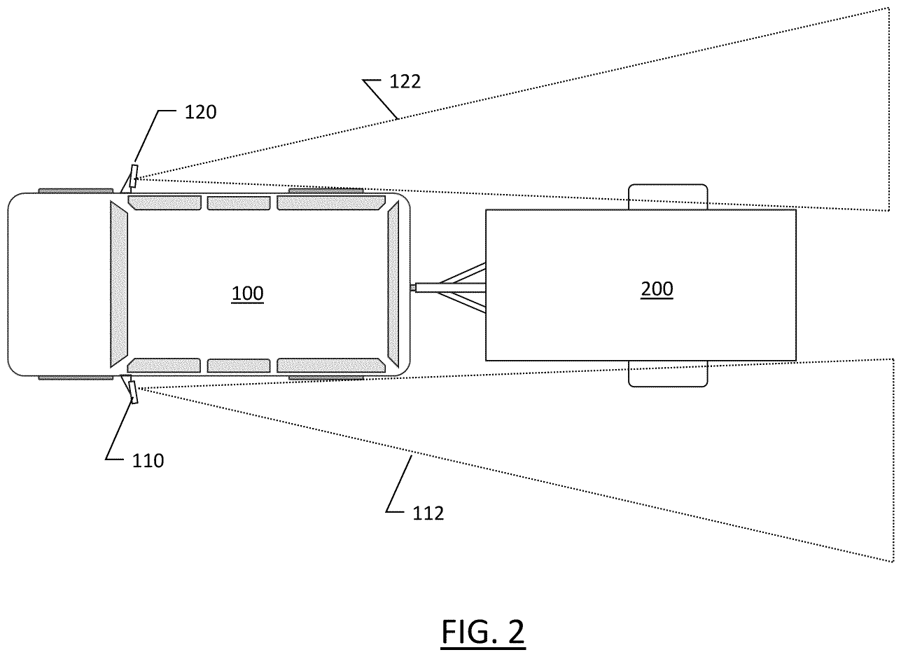

When a vehicle tows a trailer, particularly a trailer with some degree of height (e.g., a box trailer, camper trailer, etc.) the rear view is compromised and a driver's ability to see aft of the vehicle becomes significantly limited. FIG. 2 illustrates the vehicle 100 towing a trailer 200. As shown, the trailer 200 is largely outside of the left side field of view 112 and right side field of view 122. Objects or vehicles directly aft of the trailer 200 may not be visible to a driver since the rear view mirror and/or rear view camera would both be obstructed by the trailer. To improve visibility of the trailer 200 and objects or vehicles aft of the trailer, embodiments provided herein include extended mirrors that are deployable as needed.

Vehicle side mirrors can be challenging for automotive designers. A large mirror provides a large viewing area for a driver, but compromises aerodynamics, appearance, fuel economy, and forward visibility blocked by such a mirror. Smaller mirrors are generally better for vehicle dynamics but may limit a driver's field of view. Further, side mirrors are often a source of wind noise, particularly when those mirrors are larger. Thus, compromises are often made in the design and implementation of vehicle side mirrors.

Embodiments provided herein include deployable mirrors that improve visibility particularly when a vehicle is towing a trailer. The deployable nature of the embodiments described herein allows for a relatively compact form factor for a conventional side mirror with a second mirror that can be deployed on an as-needed basis such that the deployable mirror does not adversely impact vehicle dynamics (e.g., aerodynamics, wind noise, etc.) when in the stowed position.

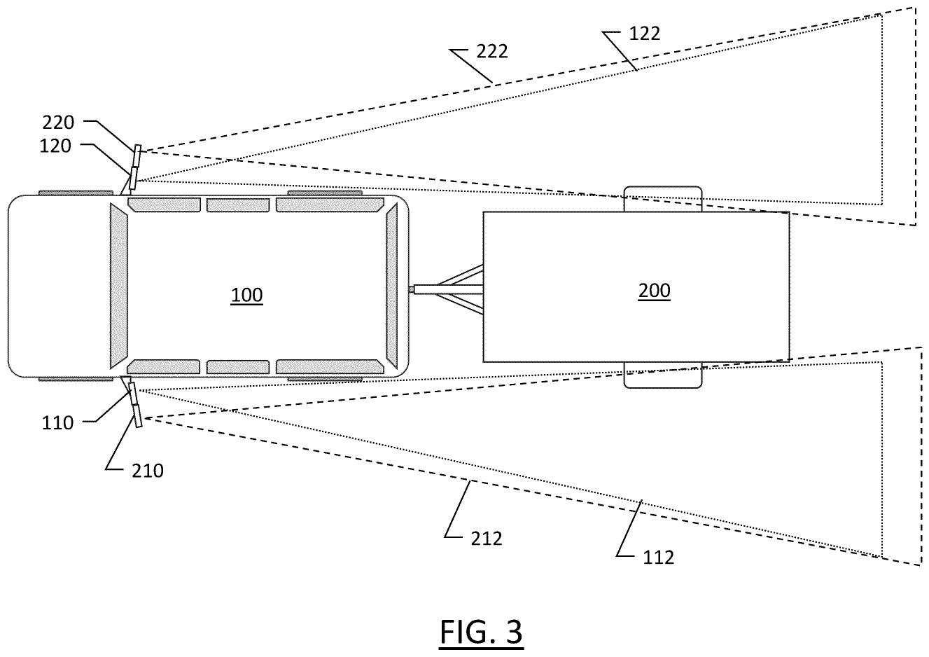

FIG. 3 illustrates the vehicle 100 towing trailer 200 with the left side mirror 110 having left side field of view 112 and right side mirror 120 having right side field of view 122. Also shown is a left side deployable mirror 210 and a right side deployable mirror 220. These deployable mirrors extend further away from a respective side of the vehicle 100 thus giving them a better position to view the trailer 200 and objects or vehicles aft of the trailer. As shown, a left side extended field of view 212 is visible from the left side deployable mirror 210 while a right side extended field of view 222 is visible from the right side deployable mirror 220. As shown, these extended fields of view provide better visibility of the trailer 200 and any objects or vehicles aft of the trailer.

The deployable mirrors in the deployed position (shown in FIG. 3) may reduce aerodynamic efficiency and hence vehicle range or fuel efficiency; however, the deployable mirrors may be designed to minimize their disruption to the airflow around the vehicle side mirrors. Further, the deployable mirrors provide improved visibility of the trailer 200 thereby improving safety with a minor decrease in efficiency associated with the deployable mirrors.

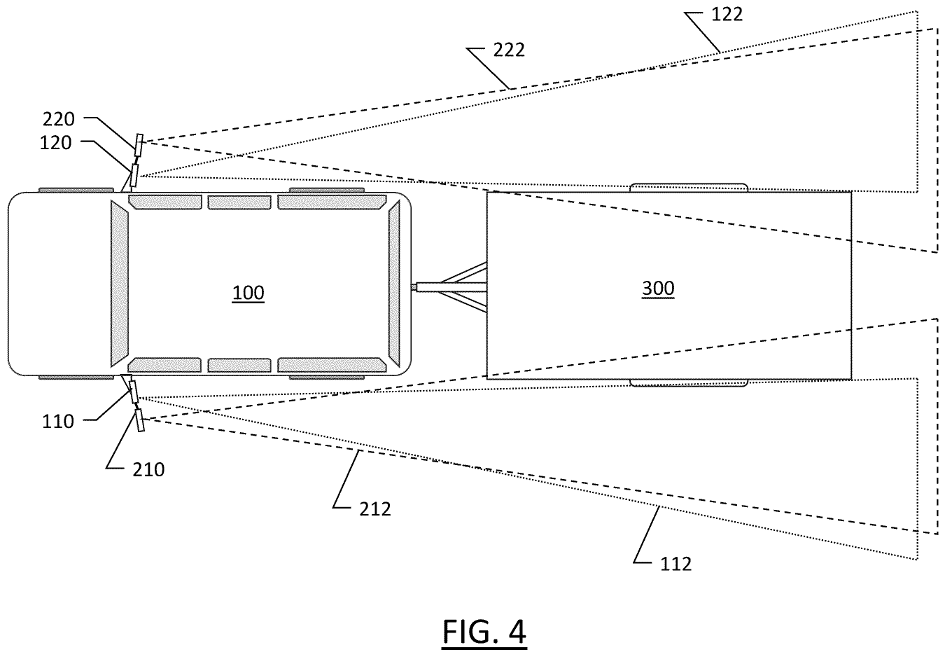

While FIG. 3 depicts the deployable mirrors in the deployed position, embodiments provided herein may include a further deployed position, where the deployable mirrors are deployed to a position further still from a respective side of the vehicle. FIG. 4 illustrates such an embodiment where a large trailer 300 benefits from enhanced visibility provided by the left deployed mirror 210 and right deployed mirror 220 in extended positions beyond the first deployed position of FIG. 3. These positions put the deployable mirrors in a position to better view the large trailer 300 and any objects or vehicles aft of the large trailer.

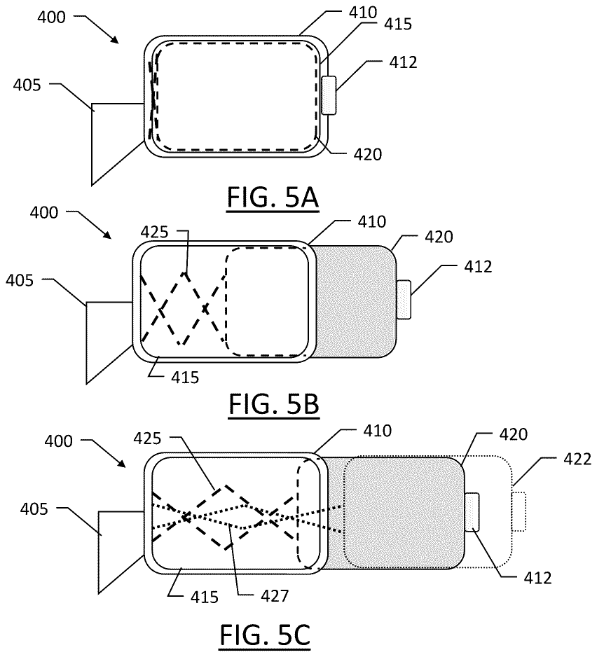

The deployable mirrors of the embodiments described herein can be deployed in a number of ways. FIG. 5A illustrates an example embodiment of a side mirror assembly 400 with a deployable mirror. As shown, the mirror assembly 400 is attached to the side of a vehicle, such as to the door or A-pillar, for example, by an arm 405. The arm 405 depicted is merely an example and not inclusive of all types of attachments between the mirror assembly 400 and the vehicle. Also shown is mirror housing 410. The mirror housing 410 includes the vehicle side mirror 415 that is visible to a driver of the vehicle. Shown in dashed lines is the deployable mirror 420, which in the illustrated embodiment is tucked within the mirror housing 410 behind the side mirror 415. The mirror assembly 400 may optionally include illumination, such as with a side marker lamp 412 which can be affixed to or part of the mirror housing 410, and/or part of the deployable mirror 420. The side marker lamp 412 may be illuminated with the lights of the vehicle (e.g., parking lights and/or head and taillights) and may be configured to flash with a turn signal on the corresponding side of the vehicle. Integrating the side marker lamp 412 with the deployable mirror 420 may be beneficial as shown in FIGS. 5B and 5C to provide an indication of the added width of the vehicle due to the deployed mirrors. This can be beneficial for both the driver for navigating tight spaces and for other vehicles on the road to better see the vehicle having the mirrors deployed.

Applicant notes that while the deployable mirrors of the illustrated embodiments of FIGS. 5A-C, 6A-C, and 7A-C are found within their respective mirror housing, according to some embodiments, the deployed mirror may be the vehicle side mirror that moves relative to a stationary mirror housed behind the deployable vehicle side mirror as described further below. The side mirror and the deployable mirror of example embodiments described herein can be the same size as one another, similar sizes, or one larger than the other without deviating from embodiments described herein.

FIG. 5B illustrates the mirror assembly 400 of FIG. 5A with the deployable mirror 420 advanced toward a deployed position, where the deployable mirror 420 is advanced away from the side of the vehicle to which the arm 405 is mounted. The mechanism employed to deploy the deployable mirror 420 of FIGS. 5A-5C is a scissor mechanism 425 which pushes the deployable mirror out of the mirror housing 410 as the ends of the scissor mechanism are squeezed together. FIG. 5C illustrates the deployable mirror 420 in the fully deployed position. The position shown in FIG. 5B may be a deployed position, such as the position of the deployable mirror 220 of FIG. 3, while the position shown in FIG. 5C may be a further deployed position as shown as the position for deployable mirror 220 of FIG. 4. Also shown in FIG. 5C in dotted lines is a still further deployed position, where the mirror 422 in the still further deployed position extends entirely out from within the deployable mirror housing 410, and the scissor mechanism 427 in the still further deployed position functions as an extension arm to extend the deployable mirror 422 beyond the housing.

The side mirror 415 and the deployable mirror 420 may each be separately adjustable, such as adjustable about two orthogonal axes that are each in the plane of the respective mirror. The side mirror 415 and/or the deployable mirror 420 may optionally be convex to a limited degree to permit a greater field of view; however, even with some degree of convexity, the respective mirror generally defines a plane through which the two axes of adjustment pass. A vehicle employing the deployable mirrors described herein may have two side mirrors and two deployable mirrors. Each of these four mirrors may be convex to some degree, and the degree may vary based on the position of each mirror. For example, a driver's side mirror may be minimally convex or not convex, while a driver's side deployable mirror may be more convex than the driver's side mirror. A passenger side mirror may be convex, and the passenger side deployable mirror may be more convex. The degree to which a mirror is convex can increase the field of view, but also can distort the field of view. As such, the convex nature of the mirrors of example embodiment can range from no convex shape to significant convex shape, and each mirror may be convex to a different degree.

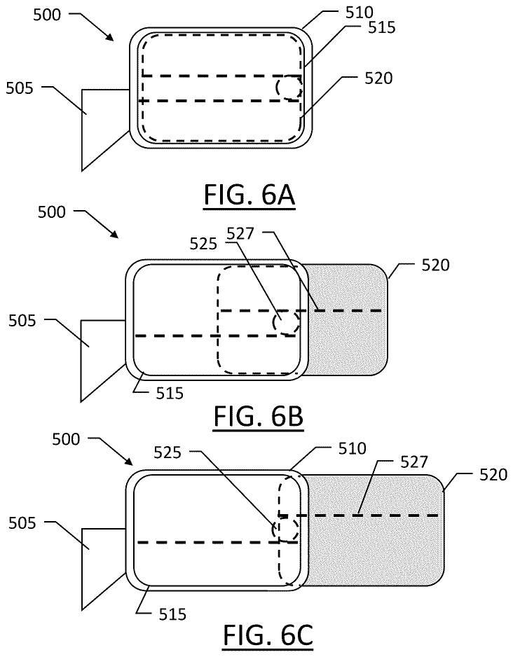

FIGS. 6A-C illustrate another mechanism for advancing the deployable mirror to the deployed position. As shown, the mirror assembly 500 is mounted to an arm 505 and includes mirror housing 510. The vehicle side mirror 515 is visible to a driver of the vehicle in FIG. 6A, while the deployable mirror 520 shown in dashed lines is not visible. In FIG. 6B, the deployable mirror is advanced toward a deployed position by a rack 527 and pinion 525 arrangement, whereby rotation of the pinion 525 gear advances the rack 527 attached to the deployable mirror 520. FIG. 6C illustrates the deployable mirror 520 in the deployed position with the pinion 525 having reached the end of the rack 527.

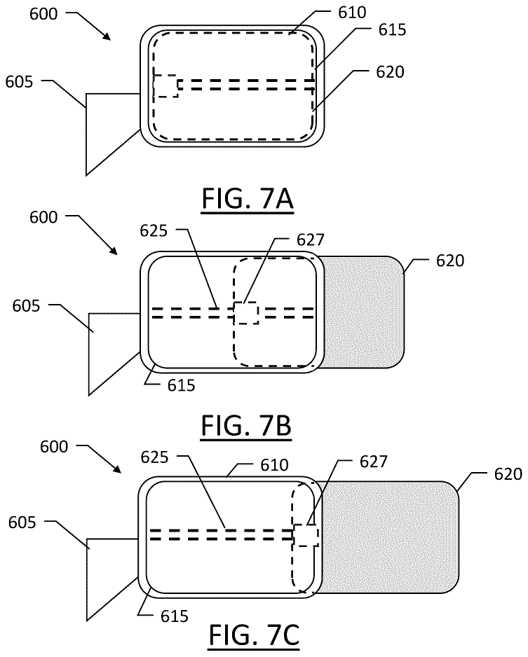

FIGS. 7A-7C illustrate yet another mechanism for advancing the deployable mirror to the deployed position. As shown, the mirror assembly 600 is mounted to an arm 605 and includes mirror housing 610. The vehicle side mirror 615 is visible to a driver of the vehicle in FIG. 7A, while the deployable mirror 620 shown in dashed lines is not visible. In FIG. 7B, the deployable mirror is advanced toward a deployed position by a ball screw 627 and threaded shaft 625. As the threaded shaft 625 is rotated, the ball screw 627 advances linearly to deploy the deployable mirror 620. FIG. 6C illustrates the deployable mirror 620 in the deployed position with the ball screw 627 having reached the end of travel on the threaded shaft 625.

As evidenced by the above, various mechanisms may be used to impart linear motion to a deployable mirror housed within a mirror housing to deploy the mirror. Embodiments are not limited to the mechanical linear actuation as described above, as numerous other linear actuation mechanisms can be employed.

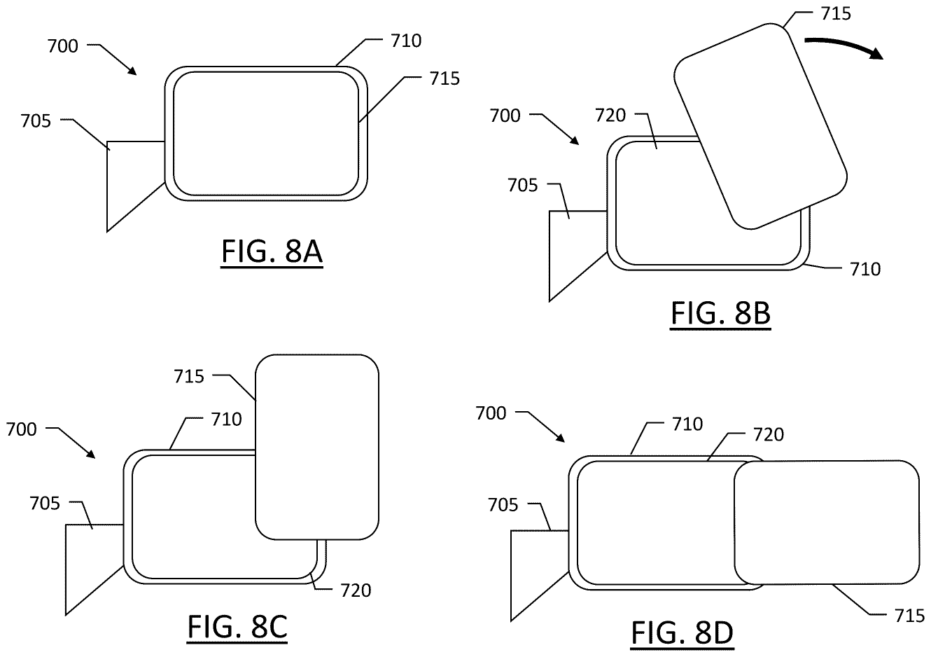

Beyond linear movement of a first mirror (e.g., the vehicle side mirror) relative to a second mirror (e.g., the deployable mirror), embodiments can include other deployment mechanisms. For example, a rotational deployment of a deployable mirror. FIGS. 8A-D illustrate such an embodiment. Further, according to the illustrated embodiment of FIGS. 8A-D, the vehicle side mirror becomes the deployed mirror, while a mirror that remains stationary is hidden behind the deployable mirror when it is in the stowed position.

FIG. 8A illustrates a mirror assembly 700 of a deployable mirror. The mirror assembly 700 is attached to a vehicle with arm 705. The mirror assembly includes mirror housing 710 and the vehicle side mirror 715. Deployment of the deployable mirror begins with rotation of the vehicle side mirror 715 as shown in FIG. 8B, revealing stationary mirror 720. A first deployed position may be when the vehicle side mirror 715 is rotated 90-degrees relative to the mirror housing 710 as shown in FIG. 8C. The vehicle side mirror 715 may further rotate through a total of 180-degrees to reach a second deployed position as the deployed mirror as shown in FIG. 8D, while the stationary mirror 720 previously disposed behind the vehicle side mirror 715 functionally becomes the vehicle side mirror.

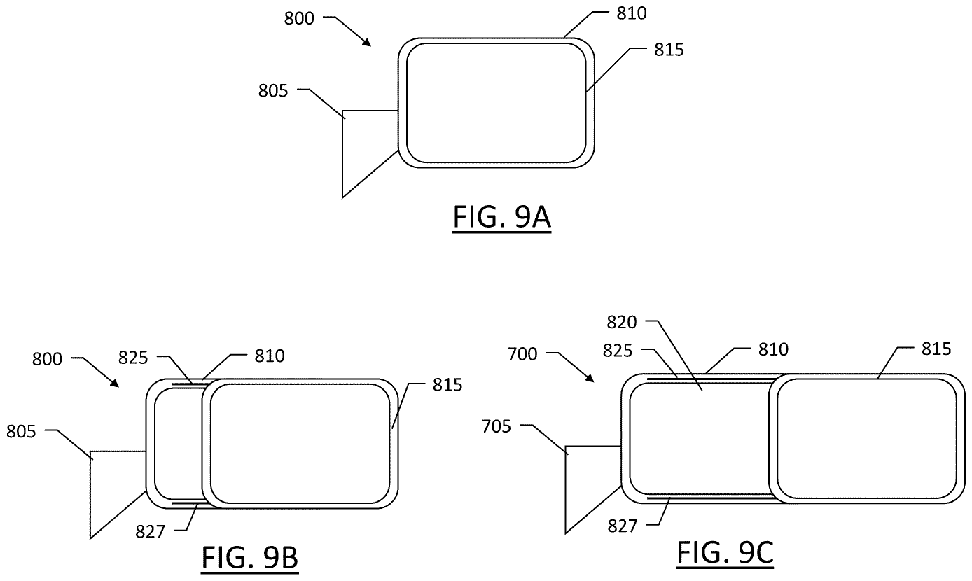

FIGS. 9A-C illustrate another embodiment of linear actuation to deploy a deployable mirror. However, as with the embodiment of FIGS. 8A-C, the vehicle side mirror becomes the deployed mirror. As shown in FIG. 9A, the mirror assembly 800 is attached to a vehicle by arm 805 and includes mirror housing 810 and vehicle side mirror 815. FIG. 9B illustrates the vehicle side mirror 815 advancing to a deployed position where the vehicle side mirror 815 is riding on tracks 825 and 827 within the mirror housing 810. FIG. 9C illustrates the vehicle side mirror in the deployed position revealing stationary mirror 820 which functionally becomes the vehicle side mirror while the original vehicle side mirror 815 becomes the deployed mirror.

Each of the aforementioned embodiments includes a first mirror and a second mirror, where the first mirror moves relative to the second mirror. The mirror that moves becomes the deployed mirror in each embodiment, whether it begins as the vehicle side mirror in the stowed position, or a stowed mirror hidden from view. As noted above, both the first mirror and the second mirror are adjustable along perpendicular axes substantially defined through a plane of the respective mirror. The first mirror and the second mirror can each be adjusted independently from one another. Further, each mirror may be able to rotate in addition to being able to tilt up/down and left/right.

Embodiments described herein can deploy the deployable mirror in circumstances that warrant such an added mirror for improved visibility. Deployment of the mirror can be automated such that the deployed mirror becomes available to a driver in anticipation of the driver requiring greater visibility from the vehicle side mirrors. Optionally, a user may be able to deploy the deployable mirrors through user input, such as through a user interface.

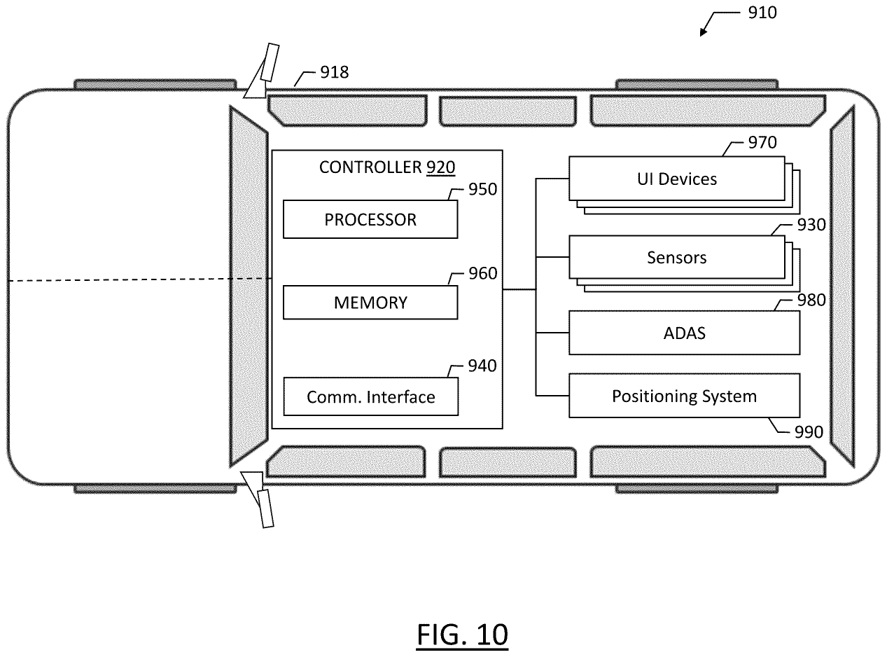

A user interface of embodiments described herein can be controlled, for example, using a controller where the controller may be embodied as a vehicle controller or a sub-unit controller of the vehicle, such as an infotainment system controller, etc. FIG. 10 is a schematic diagram of an example embodiment of a vehicle 910 and a controller 920. The vehicle 910 is depicted with body 918 which generally encompasses the structure of the vehicle. The controller 920 of some embodiments is integrated into the vehicle 910 and connected to different elements described herein, such as through a wiring harness. The illustrated controller 920 can be embodied as any controller of the vehicle 910 for controlling any features of the vehicle 910, with the depicted features of the illustrated embodiment being optional depending upon the application. For example, as mentioned above, the controller 920 can be embodied as an infotainment system controller; however, the present disclosure is not intended to be limiting in this regard. In other embodiments, the controller 920 could be a stand-alone controller or could be embodied via another vehicle controller, such as a vehicle control unit (VCU), an Advanced Driver Assistance System (ADAS) controller, or the like.

The controller 920 of FIG. 10 can be configured to perform any of the operations described herein. Controller 920 is an example embodiment that may be embodied by or associated with any of a variety of computing devices that include or are otherwise associated with a vehicle. The controller 920 can be in communication with any systems, sensors, or other controllers of the vehicle 910, such as via a communications interface (e.g., a CAN bus). According to some embodiments, the controller 920 can include a computing device that provides instructions or commands to a vehicle control module or other vehicle controller, where the controller is a device in communication with various vehicle systems and control architectures. In this manner, some embodiments can be implemented on purely in-vehicle systems, through mobile devices commanding in-vehicle systems, or a combination thereof. One such example is a winch operated by a remote device, such as a remote controller, smart phone, or the like, which may be used in embodiments described herein.

Optionally, the controller 920 may be embodied by or associated with a plurality of computing devices that are in communication with or otherwise networked with one another such that the various functions performed by the apparatus may be divided between the plurality of computing devices that operate in collaboration with one another.

The controller 920 may include, be associated with, or may otherwise be in communication with a communication interface 940, a processor 950, and a memory 960. The controller 920 may be in communication with one or more user interface devices 970, such as one or more displays that may include touch screen displays. In some embodiments, the processor 950 (and/or co-processors or any other processing circuitry assisting or otherwise associated with the processor) may be in communication with the memory 960 via a bus for passing information among components of the controller. The memory 960 may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor). The memory 960 may be configured to store information, data, content, applications, instructions, or the like for enabling the apparatus to carry out various functions in accordance with an example embodiment of the present disclosure. For example, the memory 960 could be configured to buffer input data for processing by the processor. Additionally or alternatively, the memory 960 could be configured to store instructions for execution by the processor.

The processor 950 may be embodied in a number of different ways. For example, the processor 950 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 950 may include one or more processing cores configured to perform independently. A multi-core processor may enable multiprocessing within a single physical package. Additionally or alternatively, the processor 950 may include multiple processors configured in tandem via the bus to enable independent execution of instructions, pipelining and/or multithreading.

In an example embodiment, the processor 950 may be configured to execute instructions stored in the memory 960 or otherwise accessible to the processor. Alternatively or additionally, the processor 950 may be configured to execute hard coded functionality. As such, whether configured by hardware or software methods, or by a combination thereof, the processor 950 may represent an entity (for example, physically embodied in circuitry) capable of performing operations according to an embodiment of the present disclosure while configured accordingly. Thus, for example, when the processor 950 is embodied as an ASIC, FPGA or the like, the processor 950 may be specifically configured hardware for conducting the operations described herein.

Alternatively, as another example, when the processor 950 is embodied as an executor of software instructions, the instructions may specifically configure the processor 950 to perform the algorithms and/or operations described herein when the instructions are executed. However, in some cases, the processor 950 may be a processor of a specific device (for example, the computing device) configured to employ an embodiment of the present disclosure by further configuration of the processor by instructions for performing the algorithms and/or operations described herein.

As noted above, the controller 920 of an example embodiment may also include or otherwise be in communication with one or more user interface devices 970. The user interface devices 970 can include any feature of the vehicle 910 that a user interacts with including features such as climate control, infotainment interface, gauge cluster, mirror control, camera control, etc. In this regard, the user interface devices 970 may include or otherwise be in communication with one or more displays, such as an infotainment system display, a gauge cluster, an entertainment system display (e.g., for rear seat passengers) or the like. The user interface devices 970 may optionally include one or more speakers, physical buttons, analog display (e.g., speedometer, fuel gauge, etc.) and/or other input/output mechanisms. The user interface devices 970 may be incorporated into the vehicle 910, such as a dedicated navigation system display/audio system or a device that can attach or associate with the vehicle via communication link. In an example embodiment, the processor 950 may include user interface circuitry configured to control at least some functions of one or more input/output mechanisms. The processor 950 and/or user interface circuitry comprising the processor 950 may be configured to control one or more functions of one or more input/output mechanisms through computer program instructions (for example, software and/or firmware) stored on a memory accessible to the processor (for example, memory 960, and/or the like).

As shown, the vehicle 910 may be equipped with any number of sensors 930. As described herein, a “sensor” refers to any sensing device which can be used to determine properties of the environment of the vehicle 910, properties of the vehicle itself, forces applied from/to the vehicle, or the like. Accordingly, the sensors 930 can include, but are not limited to, image sensors, LiDAR sensors, wheel speed sensors, and/or tire pressure sensors, among various other types of sensors. For example, the sensor 930 can determine a speed of movement of the vehicle in some embodiments. As another example, the sensor can determine a current tire pressure of a tire of the vehicle.

It should be appreciated that the vehicle 910 may include a number of other sensors which may not be explicitly illustrated. For example, the vehicle 910 may include one or more of an accelerometer, a gyroscope, and a speed sensor (e.g., wheel speed sensors) to sense information regarding the movement, positioning, or orientation of the vehicle 910, e.g., for use in navigation assistance. In one such example, the vehicle 910 (or the controller 920 itself) could include an inertial measurement unit (IMU) that functions as an accelerometer and a gyroscope. The vehicle 910 may also include a light sensor, various image sensors (e.g., cameras), and more. As described in greater detail below, for example, the vehicle 910 may include various sensors and/or transceivers used for detecting a position, speed, etc. (e.g., for navigation) and/or for implementing various driving aids (e.g., parking sensors, radar for automatic cruise control and/or automated braking, cameras for lane center and object avoidance, etc.).

The controller 920 of an example embodiment may also optionally include a communication interface 940 that may be any means such as a device or circuitry embodied in either hardware or a combination of hardware and software that is configured to receive and/or transmit data from/to other electronic devices in communication with the controller 920. Additionally or alternatively, the communication interface 940 may be configured to communicate over any wired or wireless communication protocols. In some environments, the communication interface 940 may alternatively or additionally support vehicle to vehicle or vehicle to infrastructure wireless links.

The controller 920 of an example embodiment can be embodied by or otherwise in communication with various other vehicle controllers which can be separate or in a single module; however, it will be appreciated that these controllers function in concert to enable various aspects of vehicle functionality. As such, the controller 920 can be interpreted as a general controller performing each of these functions to enable vehicle functionality accordingly.

As shown, the vehicle 910 can further include an advanced driver assistance system (ADAS) 80 configured to perform various driver-assistance functions of a vehicle, including control features that may be part of autonomous control of a vehicle, such as adaptive headlight aiming, adaptive cruise control, lane departure warning and control, curve warning, and hazard warning, among others.

The ADAS 980 may be used to provide various functionality of a vehicle and may be implemented to improve the comfort, efficiency, safety, and overall satisfaction of driving. Some of these advanced driver assistance systems use a variety of sensors in the vehicle to determine the current state of the vehicle and the current state of the roadway ahead of the vehicle. These sensors may include radar, infrared, ultrasonic, and vision-oriented sensors such as image sensors and light distancing and ranging (LiDAR) sensors. According to some embodiments, and which may be particularly useful for off-road capable vehicle, the sensors of an ADAS 980 can include, for example, various cameras such as cameras directed to the wheels and terrain proximate the wheels to help guide a driver/occupant with respect to how to navigate challenging off-road terrain. These cameras can be in the vehicle and/or around the exterior of the vehicle, such as in a wheel arch, fender flare, wing mirror, bumper, brush guard, etc.

The vehicle 910 can optionally include a positioning system 990 which may be in communication with controller 920 as shown in FIG. 1. The positioning system can include any type of Global Navigation Satellite Systems (GNSS) such as the Global Positioning System (GPS), BeiDou Navigation Satellite System (BDS) positioning system, Galileo positioning system, or any other standardized positioning system. The positioning system 990 can optionally include systems that are not satellite-based, but use other methods of localization, such as wireless access point triangulation or the like. The positioning system 990 can be used in conjunction with the ADAS 980 or user interface devices 970 such as a navigation system, for example. The positioning system 990, if employing a highly accurate localization technique, may be able to determine speed of movement of the vehicle and/or may otherwise be used to supplement other speed of movement determinations (e.g., using wheel speed sensors). While vehicle speed can be discerned from GNSS, such vehicle speed is more accurate at relatively higher speeds (e.g., more than 20 miles per hour), while GNSS are not generally effective at very low speeds (e.g., less than 5 miles per hour), such that the positioning system 990 may be employed for low-speed determination only in certain circumstances.

The deployment of a deployable mirror as described with respect to FIGS. 3-9C can be commanded in a number of different ways. One such example is user selection of deployment, which may be achieved via a user interface which can take the form of a user interface device 970 such as a button, switch, or virtual control (e.g., on a display device). The user may determine that the additional visibility offered by deployable mirrors is desirable, such that the user may directly command deployment of the deployable mirror through positive command received at a user interface.

Embodiments described herein optionally deploy the deployable mirror under certain circumstances when the controller 920 determines that deployment is appropriate and/or necessary. One such mechanism for automatic deployment is if a ‘tow mode’ is entered. As discussed herein, ‘tow mode’ refers to a particular operating mode of vehicle 910, e.g., which affects operations of vehicle 910. In this regard, vehicle 910 may be operated in various operating modes (e.g., as controlled by controller 920 and/or other vehicle controllers) that define characteristics of vehicle 910. For example, a ‘sport mode’ may increase the throttle response, stiffen suspension, modify user interfaces, and/or otherwise affect the characteristics of vehicle 910. Likewise, responsive to a user activating ‘tow mode,’ various characteristics and/or operations of vehicle 910 may change. For example, a central display of vehicle 10 may display a ‘tow mode’ specific user interface, e.g., which displays relevant data such as load measured at an electric drive train, weight distribution between front wheels and rear wheels, tire pressure, etc. In addition, operations of the powertrain of vehicle 910 may be adjusted or otherwise controlled in a manner different to a so-called “normal” operating mode of vehicle 910. When a user selects ‘tow mode’, deployable mirrors may automatically deploy to better prepare the vehicle for towing. Optionally, a ride height may be set based on the tow mode and a stiffness of rear suspension may be altered to improve vehicle performance while towing.

In addition to or in lieu of such a ‘tow mode’, a vehicle may be configured to detect the presence of a trailer and to automatically take one or more actions in response. For example, if a trailer wire harness is connected to a vehicle wire connector for trailer lights and a trailer brake if so equipped, the controller 920 may establish that the vehicle will be towing a trailer. The controller 920 may detect a trailer wire harness connected to the wire connector such as by detecting a resistance between pins of the connector, for example. In such an embodiment, upon the controller 920 detecting the trailer wire harness, the deployable mirrors may be automatically deployed by the controller.

According to some embodiments, a controller 920 of a vehicle 910 may determine deployment of deployable mirrors is appropriate when a trailer is detected behind the vehicle. A rear view camera or image sensor of a vehicle (e.g., sensor 930) may use object recognition to identify a trailer present behind the vehicle, at which point the controller 920 may command deployment of the deployable mirrors. Object recognition may not be necessary if a rear view camera of a vehicle detects a substantially unchanging view while the vehicle is driving. In such an example embodiment, the controller 920 may determine that there is a trailer present, such that deployment of the deployable mirrors is appropriate.

Regardless of how a determination is made to command deployment of deployable mirrors, there are several mechanisms by which the retraction of the deployed mirrors may be commanded. One such mechanism is through user interface. While deployed mirrors may provide improved viewing aft of the vehicle, they also generally increase a width of a vehicle which can be challenging in certain environments such as narrow parking spaces. A user can provide a user input, such as via a UI device 970 to retract the deployed mirrors. Such a user input causes the deployable mirrors to retract to the stowed position. Once the situation necessitating the retraction is past, such as if the user has left the narrow parking space, then the user can re-command deployment of the deployable mirrors as necessary.

Beyond user command, the controller 920 of example embodiments can automatically retract the deployed mirrors to the stowed position in some circumstances. For example, if a ‘tow mode’ is exited by a user, the deployed mirrors may be automatically retracted. Exiting a ‘tow mode’ may be performed by a user selecting a different mode of operation. While in ‘tow mode’, if a user places a vehicle into ‘Park’, the deployed mirrors may be retracted. The vehicle being placed in ‘Park’ will often mean that a driver may exit the vehicle, and deployed mirrors may become an obstacle to avoid while one or more people move near the vehicle. Further, placing a vehicle in ‘Park’ is generally a precursor to turning off a vehicle, in which case the deployed mirrors should generally be retracted to avoid becoming obstacles and to reduce the likelihood of damage from other vehicles.

The controller 920 may optionally determine to retract deployed mirrors in response to determining that a trailer is no longer being towed by the vehicle. This may be determined based on a rear view camera or image sensor (e.g., sensor 930) determining that the trailer is no longer present through object detection at the controller 920 or through detecting moving terrain behind the vehicle. According to another embodiment, the controller 920 may determine that a trailer is no longer being towed by determining that a trailer wire harness is no longer connected to a vehicle wire connector. In each of these cases, the controller 920 may automatically command retraction of the deployed mirrors.

In each of the automated retraction scenarios, a user may override the controller 920. For example, a user may program a setting to keep the deployed mirrors deployed at all times. Such a setting may be useful for a vehicle that is used in a setting where trailers are attached and detached frequently and where the potential negative impacts of deployed mirrors are less important. One such example may be a farm where a vehicle is unlikely to encounter narrow parking spaces or be concerned with wind noise or aerodynamics associated with a deployed mirror.

The deployment of the deployable mirrors may be based on a user preference. For example, one particular user may tend to use a vehicle to tow a trailer, while another user may not. In such a scenario, the deployment of a mirror may be based on the user preference, where the user is identified based on a key or mobile device used to enter and/or start the vehicle. While “keyless” key fobs are often used to access and start a vehicle, mobile devices such as mobile phones may be used in place of such key fobs. These mobile devices, much like the key fobs, may have their own unique identifiers such that a vehicle can differentiate between mobile devices and associate a user profile with a mobile device in order to configure preferred settings of a vehicle upon approach or entry of that mobile device into the vehicle.

In addition to deployment determinations based on user profiles, a position setting of each mirror may be established based on a profile of a user. When the deployable mirrors are not deployed, user preferences may be employed to position the vehicle side mirror in terms of angle of adjustment along two perpendicular axes. When a user approaches or enters the vehicle, the user may be identified, such as based on a key fob or mobile device, and the vehicle side mirror position may be adjusted accordingly. When a deployable mirror is deployed, a position of the deployable mirror and adjustment thereof along two perpendicular axes may be determined based on preferences of the driver of the vehicle, where the driver is established based on the presence of a key fob or mobile device. When a deployable mirror is deployed and adjusted, the vehicle side mirror may also be adjusted to a different position than when the deployable mirror is not deployed.

In addition to or in combination with storing user profiles for deployable mirror positions, trailer profiles may be stored and associated with different deployable positions. For example, a flatbed trailer may not require a fully deployed mirror as the driver may be able to see over the trailer in the mirror. A flatbed trailer profile may thus partially deploy a deployable mirror. A long box trailer may be associated with a trailer profile that fully deploys the deployable mirror as it is necessary to see beyond the large trailer.

Deployable mirrors as described herein provide a vehicle side mirror that is generally indiscernible from a conventional vehicle side mirror when the deployable mirror is stowed but is fully electronically deployable from within the vehicle (or on approach to the vehicle as described above). The deployable mirror provides adjustable positions and positions that can be memorized for automatic adjustment based on a driver profile, a trailer profile, or through the use of one or more buttons or switches that are each associated with a deployed position and mirror adjustment. The deployable mirrors described herein can require less convex curvature as they can be moved away from the vehicle to a position better suited for viewing the trailer and trailer surroundings. Further, while some after-market trailer mirrors can be clipped on, embodiments of the deployable mirrors described herein are integrated into a mirror housing providing a more stable mirror and less shaking to provide clearer viewing and safer operation. The vehicle side mirrors and deployable mirrors are each remotely independently adjustable to allow a driver to configure the mirrors in the ideal position to provide the best view of a trailer and its surroundings.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed, and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A mirror system for vehicle, the mirror system comprising:
a mirror housing;
a first mirror;
a second mirror; and
an actuator, wherein the actuator is configured to move the second mirror relative to the first mirror from a stowed position to a deployed position, wherein in the deployed position the first mirror and the second mirror are visible to an occupant of the vehicle, wherein in the stowed position, only one of the first mirror and the second mirror are visible to the occupant of the vehicle,
wherein the first mirror is adjustable about two perpendicular axes, wherein the second mirror is adjustable about two perpendicular axes, and wherein adjustment of the first mirror is independent of adjustment of the second mirror.

2. The mirror system of claim 1, wherein the actuator is further configured to move the second mirror relative to the first mirror from the deployed position to a second deployed position, wherein the stowed position is a first distance from a side of the vehicle, the deployed position is a second distance from the side of the vehicle, and the second deployed position is a third distance from the side of the vehicle, wherein the third distance is greater than the first distance and the second distance.

3. The mirror system of claim 2, wherein the second distance is greater than the first distance.

4. The mirror system of claim 1, further comprising a controller, wherein the controller is configured to command the actuator to move the second mirror from the stowed position to the deployed position.

5. The mirror system of claim 1, further comprising a controller, wherein the controller is configured to command the actuator to move the second mirror from the stowed position to the deployed position in response to detection of a presence of a trailer towed by the vehicle.

6. The mirror system of claim 5, wherein the detection of the presence of the trailer towed by the vehicle is based on connection of a trailer wire harness to a trailer wiring connector.

7. The mirror system of claim 5, wherein the detection of the presence of the trailer towed by the vehicle is based on a selection of a tow mode by a user of the vehicle.

8. The mirror system of claim 5, wherein the detection of the presence of the trailer towed by the vehicle is based on a trailer object detected in a rear-view camera of the vehicle.

9. The mirror system of claim 1, wherein the actuator comprises a mechanical linear actuator, and wherein the second mirror moving to the deployed position slides linearly away from the vehicle.

10. The mirror system of claim 9, wherein the second mirror in the stowed position is enclosed within the mirror housing.

11. The mirror system of claim 9, wherein the second mirror in the stowed position is in front of the first mirror.

12. The mirror system of claim 1, wherein the actuator comprises a rotating actuator, and wherein the second mirror moving to the deployed position rotates about a pivot point to the deployed position further from the vehicle than the stowed position.

13. The mirror system of claim 1, wherein the actuator is configured to move the second mirror relative to the first mirror from the stowed position to the deployed position in response to a command from a user inside the vehicle.

14. The mirror system of claim 1, wherein adjustment of the first mirror and adjustment of the second mirror is controlled by at least one user interface inside the vehicle.

15. The mirror system of claim 14, wherein adjustment of the first mirror and adjustment of the second mirror are performed in response to identifying a profile of a user of the vehicle.

16. A method of operating a mirror system for a vehicle comprising:
receiving an indication to deploy a second mirror relative to a first mirror from a stowed position to a deployed position; and
causing an actuator to move the second mirror from the stowed position to a deployed position,
wherein only one of the first mirror or the second mirror are visible in response to the second mirror being in the stowed position,
wherein both the first mirror and the second mirror are visible in response to the second mirror being in the deployed position,
wherein the first mirror is adjustable about two perpendicular axes, wherein the second mirror is adjustable about two perpendicular axes, and wherein adjustment of the first mirror is independent of adjustment of the second mirror.

17. The method of claim 16, wherein the stowed position is a first distance from a side of the vehicle and the deployed position is a second distance from the side of the vehicle, and wherein the second distance is greater than the first distance.

18. The method of claim 16, further comprising:
determining a presence of a trailer behind the vehicle,
wherein receiving an indication to deploy the second mirror relative to the first mirror from the stowed position to the deployed position is in response to determining the presence of the trailer behind the vehicle.

19. The method of claim 16, wherein receiving the indication to deploy the second mirror relative to the first mirror from the stowed position to the deployed position comprises receiving an indication from a user interface within the vehicle.

20. A computer program product comprising at least one non-transitory computer-readable storage medium having computer-executable program code portions stored therein, the computer-executable program code portions comprising program code instructions configured to:
receive an indication to deploy a second mirror relative to a first mirror from a stowed position to a deployed position; and
cause an actuator to move the second mirror from the stowed position to a deployed position,
wherein only one of the first mirror or the second mirror are visible in response to the second mirror being in the stowed position,
wherein both the first mirror and the second mirror are visible in response to the second mirror being in the deployed position,
wherein the first mirror is adjustable about two perpendicular axes, wherein the second mirror is adjustable about two perpendicular axes, and wherein adjustment of the first mirror is independent of adjustment of the second mirror.
